(19) United States
(12) Patent Application Publication
(10) Pub. No.: US 2020/0219116 A1
(43) Pub. Date: Jul. 9, 2020

(54) METHOD FOR PLANNING ASSORTMENTS OF SALE ITEMS

(71) Applicant: First Insight, Inc., Pittsburgh, PA (US)

(72) Inventors: Mangalprasad ANANDAN, Pondicherry (IN); Nicholas PETRO, Wexford, PA (US)

(73) Assignee: First Insight, Inc., Pittsburgh, PA (US)

(21) Appl. No.: 16/733,587

(22) Filed: Jan. 3, 2020

Related U.S. Application Data
(60) Provisional application No. 62/788,410, filed on Jan. 4, 2019.

(51) Int. Cl. G06Q 30/02

(52) U.S. Cl. CPC G06Q 30/0203; G06Q 30/0201; G06Q 30/0283; G06Q 30/0206

(57) ABSTRACT

A method for generating a preferred assortment of products that are intended to be offered for sale in a future time period.

### CROSS-REFERENCE TO RELATED APPLICATIONS

This application claims priority to U.S. Provisional Patent Application No. 62/788,410 filed Jan. 4, 2019, which is incorporated herein in its entirety.

### BACKGROUND OF THE INVENTION

### Field of the Invention

The presently disclosed invention relates to methods for optimizing future product offerings by manufacturers and sellers.

### Description of the Prior Art

In the prior art, various manufacturers and sellers have relied on sales data from prior sales periods to project optimum product selection and assortments for future sales periods. For example, in one method, a seller may select items intended for sale based on similarities and differences with respect to products that were sold in a prior sales period, perceived commonalities and changes in the target buyer, and other factors that the seller deems relevant. The seller then selects prices for the respective sale items—again based on sales of past items and the seller's assessment of relevant marketplace dynamics. Thereafter, the seller decides on the respective quantity of each item that the seller plans to offer. Finally, the seller allocates the sales inventory within the seller's distribution chain, weighing respective items within an assortment in a manner that the seller calculates will optimize total sales, profits, or other metric.

It has been found that planning methods that are based on sales data from prior sales periods insufficiently account for dynamics in consumer tastes and preferences and may lead to inventory shortages or excess inventory. Accordingly, there was a need in the prior art for a sales method that accounts for changes in consumer tastes and preferences from prior sales periods as well as consumer-perceived differences in items that are offered in an active sales period in comparison to other items that were previously offered in a prior sales period.

### SUMMARY OF THE INVENTION

In accordance with the presently disclosed invention, a method is described herein for developing and optimizing assortments of sale items that are offered in a field of sale items. The disclosed method includes a step of collecting consumer feedback data on potential sale items. The collected consumer feedback data concerns product offerings that are intended for sale in a future product offering. The collected consumer feedback data is taken from prospective consumers and refers to their opinions including preferences and dislikes regarding the sale items that are proposed for sale in the future sale period. The collected consumer feedback data may form the basis for elasticity in demand for the sale item based on price or another variable, and is used in the creation of a value score for each sale item. According to the disclosed method, distinct value scores are mapped to corresponding levels of sales performance. The mapping of value scores to selling level may be based on historical sales distribution of the seller in a specific category of sale items, regardless of whether or not the historical sale items have their own value scores. One or more recommended assortments of sale items are then generated from the value scores and the value score to sales data mapping.

Other objects and advantages of the presently disclosed invention will become apparent to those skilled in the art as a description of a presently preferred embodiment proceeds.

### BRIEF DESCRIPTION OF THE DRAWINGS

A presently preferred embodiment of the presently disclosed invention is shown and described in connection with the accompanying drawing wherein:

FIG. 1 is an illustration of a step of the disclosed method for generating projected selling level for distinct value scores; and

FIG. 2 is an illustrative flow chart that shows selected steps of the disclosed method.

### DISCUSSION OF A PRESENTLY PREFERRED EMBODIMENT

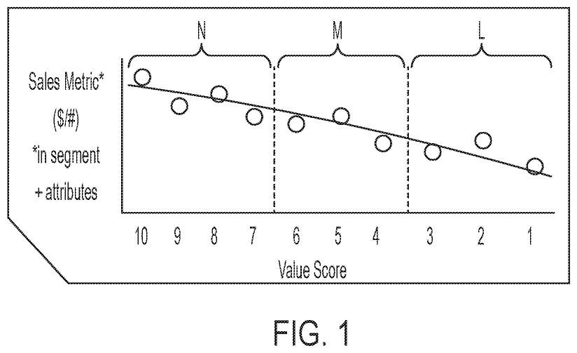

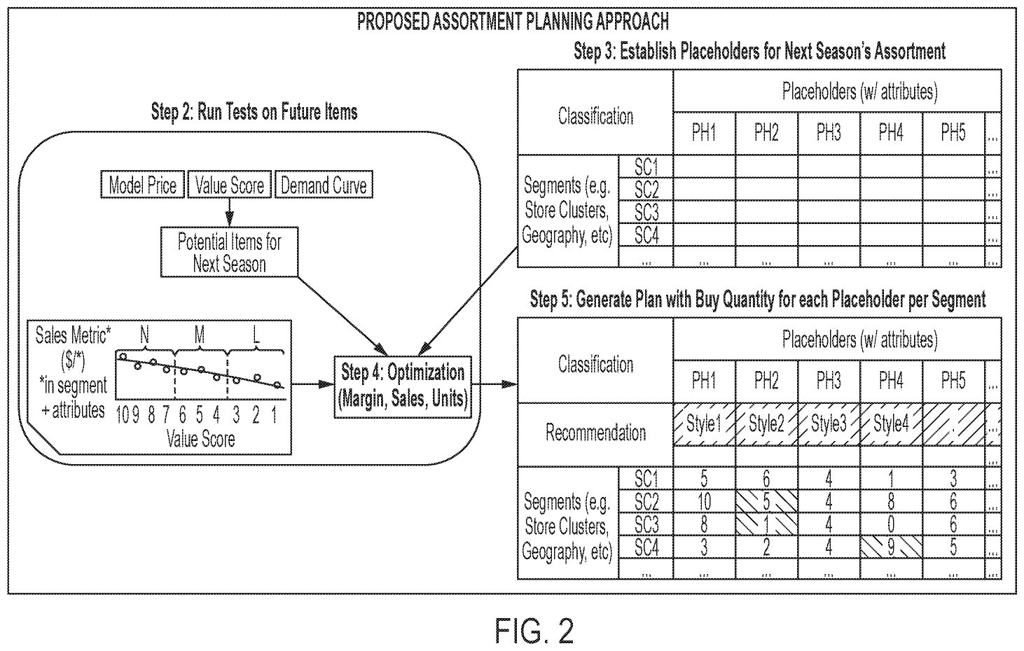

As shown and described in connection with FIGS. 1-2, the presently disclosed invention includes a method for generating proposed combinations of products in a manner that is intended to minimize inventory shortages and excesses. Typically, a seller or reseller is including an assortment or combination of sale items in an offering of products. In the presently disclosed method, a recommended selling level is assigned to products based on their value scores and historical sales mapping, in a manner that is intended to optimize one or more financial goals for the sale of the products.

The disclosed method incorporates data that reflects opinions, preferences and dislikes of consumers in the future sales period for which the product offering is currently being designed as well as sales of similar or equivalent products in product offerings of prior sales periods. Some of the relevant data is incorporated in a value score that recognizes price elasticity and is based on information from potential customers. Preferably, the information from potential consumers is developed through digital online sources such as social media of the type known to those skilled in the art. Also, preferably, the information is further developed to incorporate a predictive price elasticity curve that identifies potential for product changes (including price changes) to improve the performance of the sale item towards the goal metric (i.e. enhance the sale item contribution to a given metric such as gross sales or profit). The information from consumers as described above is combined with historical data concerning sales from a prior sales period to generate recommendations for which items should be included in a given assortment of a future product offering so as to produce optimum sales results. The recommendations thus generated may be optimized for various metrics including the number of units sold, the profit margin of units sold, and the total sales revenue. Also, underlying economic data may be used to as the basis for recommending changes to products. Such recommended changes to products could include, for example, recommended price changes based on an elasticity curve. As another example, such recommended changes to products could include recommendations for changes to certain product attributes or product features based on inferred preferences for such product attributes or product features that are inferred from said underlying economic data or inferred from other underlying data.

As shown in FIG. 1, the disclosed method includes correlating sales history of items in prior sales periods with “value scores” on a category-by-category basis. For each category of sale items, data from consumers are collected to judge price elasticity. Such data can be collected, for example, through social media platforms or other digital mechanisms. That data may then be used to develop a predictive model that accounts for price elasticity and other underlying economic effects. For some products and classes of products, such predictive models may be developed from information drawn from prior sales periods. In those cases, a correlation between value scores and a sales metric may be made by mapping the value scores to the sales metric such as prior actual sales quantities to normalize the value scores. For other products and classes of products where no predictive models have been developed, value scores may be normalized by fitting a predetermined value score distribution to a given sales level distribution. For example, a value score distribution versus a sales level distribution can be top 5% of sales equates to a value score of 10, the next 10% of sales equates to a value score of 9, etc.

With the sales history from prior sales periods correlated to value scores, the disclosed process applies data concerning sale items that are proposed for a future array of products. By way of a specific example, the price of a proposed new item, the value score corresponding to the proposed new item, and the presumed demand curve are applied to each of the new proposed items in combination with the correlation of value scores to past sales history. As illustrated in FIG. 2, this may be done through the mechanism of establishing placeholders for the future sales period assortment as shown for “Step 3.”

In the preferred embodiment, the seller's distribution system can be separated into various segments. For example, such segments can be based on combinations of retail outlets such as retail stores in a given geographical territory or retail stores of a given size. For each such segment, data is applied to populate each placeholder space. Using that data, “Step 4” of the method shown in FIG. 2, allows optimization of the proposed segment with independent evaluation of profit margin, sales volume, gross sales, or other metrics supported by the historical data. A copy of the generated plan is displayed at “Step 5” of FIG. 2.

We claim:

1. A method for planning assortments of items for sale, said method comprising the steps of:
a. collecting product feedback data from consumers for a product offering of a future sales period, wherein said feedback data defines consumer preferences for products that are proposed for inclusion in said product offering of said future sales period;
b. developing a value score based on said product feedback data for said products that are proposed for inclusion in said product offering of said future sales period;
c. mapping distinct value scores of products to corresponding selling levels of said products based on historical sales distribution of said products;
d. establishing recommended selling levels for products offered for sale based on the value score of said products offered for sale and said mapping of value scores to historical sales distribution of said products; and
e. generating at least one recommended assortment of products for sale in accordance with said value scores and said product feedback data, including underlying economic data of said developing step and in response to the sales data from said generation step.

2. The method of claim 1 wherein said value scores are associated with products within a single product category.

3. The method of claim 1 wherein said step of mapping distinct value scores comprises mapping actual sales of products that were sold in a prior sales period, said value scores being established according to proportional demand at selected price points for said products that were sold during a prior sale period.

4. The method of claim 1 wherein said step of establishing a recommended selling level comprises normalizing value scores by fitting a distribution of value scores to a sales level distribution.

5. The method of claim 1 wherein said step of generating at least one recommended assortment of products is optimized for the number of units sold.

6. The method of claim 1 wherein said step of generating at least one recommended assortment of products is optimized for the profit margin of each unit sold.

7. The method of claim 1 wherein said step of generating at least one recommended assortment of products is optimized for the maximum sales revenue.

8. The method of claim 1 wherein said step of generating assortment of sale items includes recommended changes to products from underlying economic data based on said product feedback data.
